(19) United States
(12) Patent Application Publication
(10) Pub. No.: US 2013/0127813 A1
(43) Pub. Date: May 23, 2013

(54) DISPLAY DEVICE

(71) Applicants: Chen-Tung Lee, Tainan City (TW); Ke-Jen Chen, Tainan City (TW)

(72) Inventors: Chen-Tung Lee, Tainan City (TW); Ke-Jen Chen, Tainan City (TW)

(21) Appl. No.: 13/301,750

(22) Filed: Nov. 21, 2011

(51) Int. Cl. G09G 3/36; G09G 5/00

(52) U.S. Cl. 345/212; 345/87

(57) ABSTRACT

The present invention provides a display device. The display device comprises: a timing controller, having a first number of output points; and a second number of source drivers, coupled to the first number of output points of the timing controller, respectively; wherein the first number is equal to the second number. The display device has higher resolution and fewer control pins between a timing controller and a source driver thereof. In addition, the display device provided by the present invention comprises the de-skew operation for minimizing the data and clock skew issue under high speed operation in prior art and the error bit check operation for avoiding display failure caused by error transmission.

### BACKGROUND OF THE INVENTION

1. Field of the Invention

The present invention relates to a display device, and more particularly, to a display device having higher resolution and fewer control pins between a timing controller and a source driver.

2. Description of the Prior Art

Please refer to FIG. 1. FIG. 1 shows a simplified block diagram of a conventional display device 100. As shown in FIG. 1, the display device 100 comprises: a PCB 110, a panel 112, a timing controller 114 having one output point 116 and positioned on the PCB 110, and four source drivers 120 coupled to the output point 116 of the timing controller 114 via a FPC 130 and positioned on the panel 112. In addition, a conventional interface between the timing controller 114 and each source driver 120 requires at least 20 control pins. Thus, signals between the timing controller 110 and each source driver 120 must have lower frequency, and the conventional display device 100 has lower resolution and higher cost.

### SUMMARY OF THE INVENTION

It is therefore one of the objectives of the present invention to provide a display device having higher resolution and fewer control pins between a timing controller and a source driver thereof, so as to solve the above problem.

In accordance with an embodiment of the present invention, a display device is disclosed. The display device comprises: a timing controller, having a first number of output points; and a second number of source drivers, coupled to the first number of output points of the timing controller, respectively; wherein the first number is equal to the second number.

In accordance with an embodiment of the present invention, a display device is disclosed. The display device comprises: a timing controller and a plurality of source drivers. Each source driver comprises: a comparing unit, a clock generator, a de-skew unit, a serial-to-parallel unit, and a control unit. The comparing unit is utilized for receiving a differential clock signal and a differential data signal from the timing controller, outputting a first clock signal according to the differential clock signal, and outputting a first data signal according to the differential data signal. The clock generator is coupled to the comparing unit, and utilized for receiving a synchronizing signal and the first clock signal, generating a second clock signal according to the synchronizing signal and the first clock signal, and generating a plurality of third clock signals corresponding to the second clock signal. The de-skew unit is coupled to the comparing unit, and utilized for receiving the first data signal and performing a de-skew operation for the first data signal to generate a second data signal. The serial-to-parallel unit is coupled to the clock generator and the de-skew unit, and utilized for separating the second data signal according to the third clock signals to generate a plurality of third data signals. The control unit is coupled to the serial-to-parallel unit, and utilized for receiving the second clock signal and the third data signals.

Briefly summarized, the present invention provides a display device having higher resolution and fewer control pins between a timing controller and a source driver thereof. In addition, the display device provided by the present invention comprises the de-skew operation for minimizing the data and clock skew issue under high speed operation in prior art and the error bit check operation for avoiding display failure caused by error transmission.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a conventional display device.

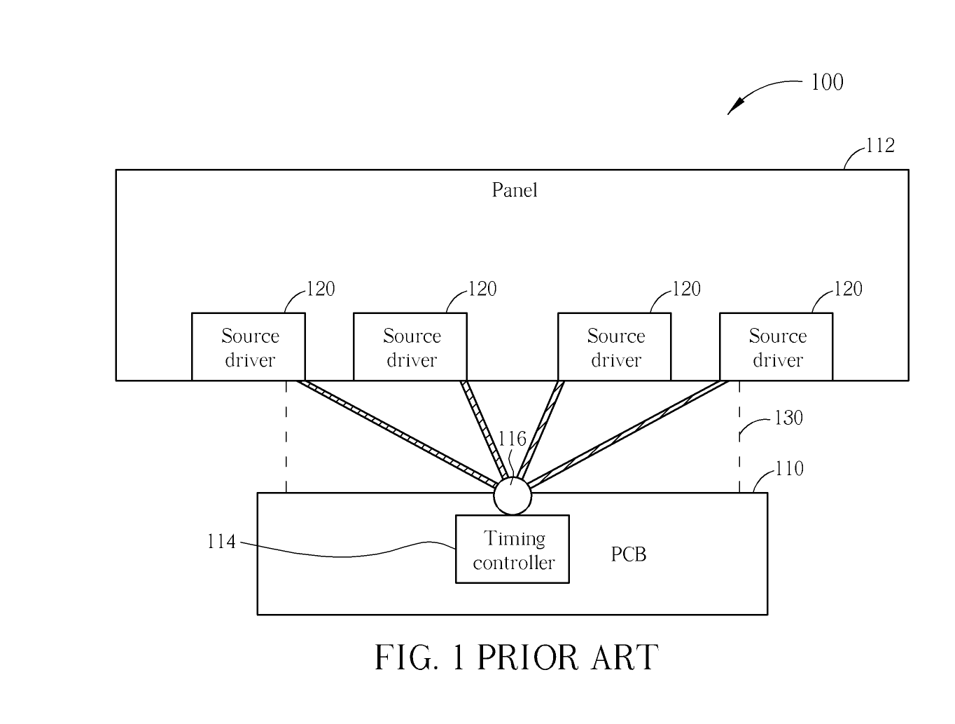

FIG. 2 shows a simplified block diagram of a display device in accordance with an embodiment of the present invention.

FIG. 3 shows a simplified block diagram of each source driver in FIG. 2.

FIG. 4 shows a simplified timing diagram of the second clock signal CLK2, the second data signal DATA2, the 6 third clock signals CLK3a˜CLK3f, and the 6 third data signals DATA3a˜DATA3f in FIG. 3.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

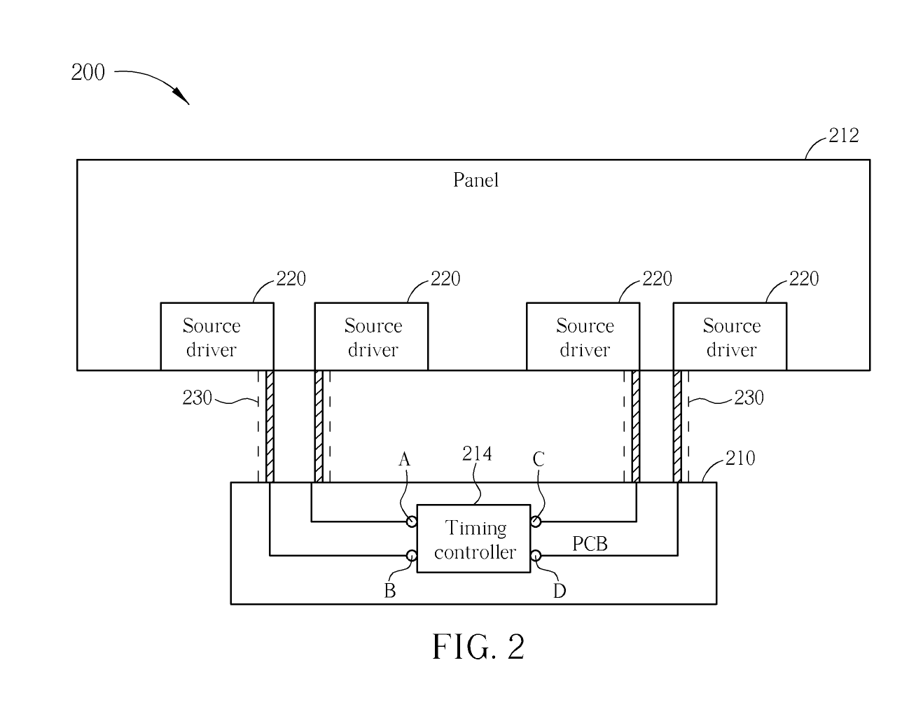

Please refer to FIG. 2. FIG. 2 shows a simplified block diagram of a display device 200 in accordance with an embodiment of the present invention, wherein the display device 200 can be a liquid crystal display (LCD) with a packet based point to point interface (PBPI). As shown in FIG. 2, the display device 200 comprises: a PCB 210, a panel 212, a timing controller 214 having four output points A, B, C, D and positioned on the PCB 210, and four source drivers 220 respectively coupled to the output points A, B, C, D of the timing controller 224 via two FPCs 230 and positioned on the panel 212, wherein each source driver 220 is a 6-bit source driver. Please note that the above embodiment is only for an illustrative purpose and is not meant to be a limitation of the present invention. For example, the number of the source drivers, FPC, and bit number of the source drivers all can be changed according to different design requirements.

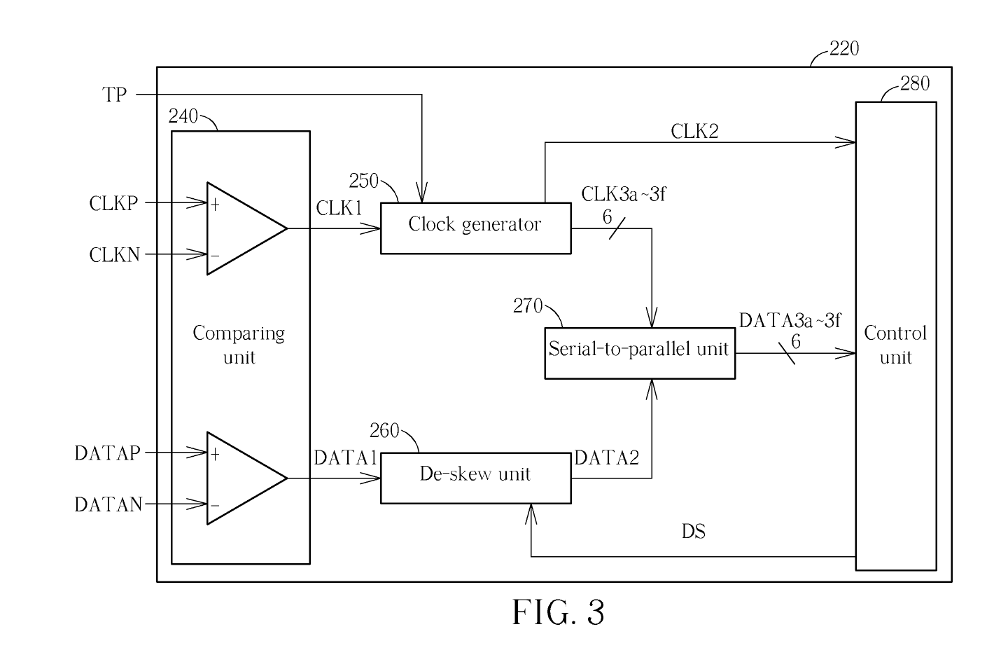

Please refer to FIG. 3. FIG. 3 shows a simplified block diagram of each source driver 220 in FIG. 2. The source driver 220 comprises: a comparing unit 240, a clock generator 250, a de-skew unit 260, a serial-to-parallel unit 270, and a control unit 280. The comparing unit 240 is utilized for receiving a differential clock signal CLKP/CLKN and a differential data signal DATAP/DATAN from the timing controller 214, outputting a first clock signal CLK1 according to the differential clock signal CLKP/CLKN, and outputting a first data signal DATA1 according to the differential data signal DATAP/DATAN. The clock generator 250 is coupled to the comparing unit 240, and utilized for receiving a synchronizing signal TP and the first clock signal CLK1, generating a second clock signal CLK2 according to the synchronizing signal TP and the first clock signal CLK1, and generating 6 third clock signals CLK3a˜CLK3f corresponding to the second clock signal CLK2. In other words, only 3 control pins (2 differential signals and 1 synchronizing signal) are required in the display device 200 in accordance with this embodiment of the present invention.

The de-skew unit 260 is coupled to the comparing unit 240, and utilized for receiving the first data signal DATA1 and performing a de-skew operation for the first data signal DATA1 to generate a second data signal DATA2. The de-skew unit 260 performs the de-skew operation for the first data signal DATA1 according to a de-skew parameter DS (such as a proper delay time for the first data signal DATA1). The de-skew unit 260 further receives a test data signal with a predetermined test pattern and generates a test output, and the control unit 280 determines the de-skew parameter DS (i.e. the proper delay time for the first data signal DATA1) according to the test output. Therefore, the present invention can make a ratio between the setup time and the hold time inside the source driver 220 to be approximately 1:1, even though there is skew between the data and the clock at inputs of the source driver 220. In other words, the data and clock skew issue under high speed operation in prior art can be minimized by the above de-skew operation provided by the present invention.

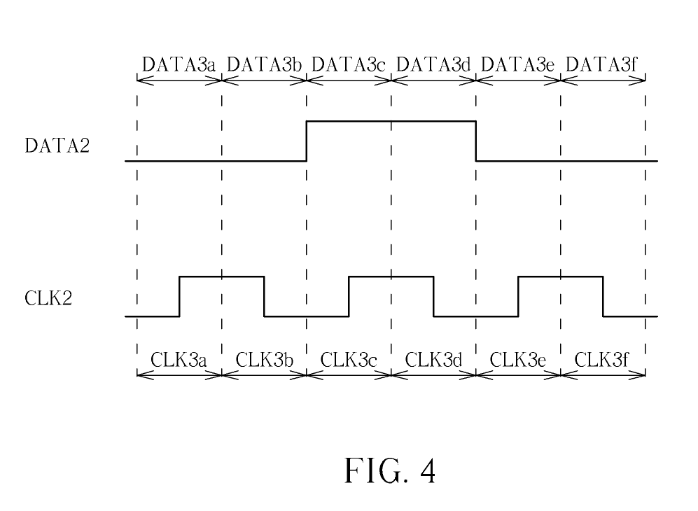

The serial-to-parallel unit 270 is coupled to the clock generator 250 and the de-skew unit 260, and utilized for separating the second data signal DATA2 according to the 6 third clock signals CLK3a˜CLK3f to generate 6 third data signals DATA3a˜DATA3f. For example, please refer to FIG. 4. FIG. 4 shows a simplified timing diagram of the second clock signal CLK2, the second data signal DATA2, the 6 third clock signals CLK3a˜CLK3f, and the 6 third data signals DATA3a˜DATA3f in FIG. 3. The control unit 280 is coupled to the serial-to-parallel unit 270, and utilized for receiving the second clock signal CLK2 and the 6 third data signals DATA3a˜DATA3f. In this way, the display device 200 provided by the present invention can have fewer control pins (only 3 control pins in this embodiment) between the timing controller 214 and the source driver 220. Thus, the panel routing can be reduced, so as to make a displayer have thinner rim and lower cost.

In addition, the timing controller 210 and the control unit 280 can perform an error bit check operation to control register updating. The error bit check operation comprises: using the timing controller 210 to calculate a first error check byte according to a first register and a second register transmitted from the timing controller 210; using the control unit 280 to calculate a second error check byte according to the transmitted first register and the transmitted second register received by the control unit 280; and using the control unit 280 to compare the first error check byte and the second error check byte to generate a comparison result to determine whether to update the first register and the second register. If the comparison result shows that the first error check byte and the second error check byte are same, then the control unit 280 updates the first register and the second register; and if the comparison result shows that the first error check byte and the second error check byte are different, then the control unit 280 does not update the first register and the second register. For example, if the first register and the second register transmitted from the timing controller 210 are respectively Reg(1) with 6-bit (110011) and Reg(2) with 6-bit (000001), then the first error check byte calculated by the timing controller 210 with XOR calculation is Par(1) with 6-bit (110010). Next, if the transmitted first register and the transmitted second register received by the control unit 280 are respectively Reg′(l) with 6-bit (100011) and Reg′(2) with 6-bit (100001), then the second error check byte calculated by the control unit 280 with XOR calculation is Par′(1) with 6-bit (000010), and since the comparison result generated by the control unit 280 shows that the first error check byte Par(1) and the second error check byte Par′(1) are different, the control unit 280 will not update the first register and the second register. On the other hand, if the transmitted first register and the transmitted second register received by the control unit 280 are respectively Reg′(1) with 6-bit (110011) and Reg′(2) with 6-bit (000001), then the second error check byte calculated by the control unit 280 with XOR calculation is Par′(1) with 6-bit (100011), and since the comparison result generated by the control unit 280 shows that the first error check byte Par(1) and the second error check byte Par′(1) are same, the control unit 280 will update the first register and the second register. In this way, the error bit check operation provided by the present invention can avoid wrong register update caused by error transmission. In other words, the error bit check operation provided by the present invention can avoid display failure caused by error transmission. Please note that the above embodiment is only for an illustrative purpose and is not meant to be a limitation of the present invention. In any case, various modifications and alterations of the device and method should fall into the disclosed scope of the present invention as long as the performances and functions of the display device having higher resolution and fewer control pins between a timing controller and a source driver and comprising the de-skew operation and the error bit check operation disclosed by the present invention can be attained.

Briefly summarized, the present invention provides a display device having higher resolution and fewer control pins between a timing controller and a source driver thereof. In addition, the display device provided by the present invention comprises the above de-skew operation for minimizing the data and clock skew issue under high speed operation in prior art and the above error bit check operation for avoiding display failure caused by error transmission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device, comprising:
a timing controller, having a first number of output points; and
a second number of source drivers, coupled to the first number of output points of the timing controller, respectively;
wherein the first number is equal to the second number.

2. The display device of claim 1, wherein each source driver comprises:
a comparing unit, for receiving a differential clock signal and a differential data signal from the timing controller, outputting a first clock signal according to the differential clock signal, and outputting a first data signal according to the differential data signal;
a clock generator, coupled to the comparing unit, for receiving a synchronizing signal and the first clock signal, generating a second clock signal according to the synchronizing signal and the first clock signal, and generating a plurality of third clock signals corresponding to the second clock signal;
a de-skew unit, coupled to the comparing unit, for receiving the first data signal and performing a de-skew operation for the first data signal to generate a second data signal;
a serial-to-parallel unit, coupled to the clock generator and the de-skew unit, for separating the second data signal according to the third clock signals to generate a plurality of third data signals; and
a control unit, coupled to the serial-to-parallel unit, for receiving the second clock signal and the third data signals.

3. The display device of claim 2, wherein the de-skew unit performs the de-skew operation for the first data signal according to a de-skew parameter; the de-skew unit further receives a test data signal with a predetermined test pattern and generates a test output; and the control unit further determines the de-skew parameter according to the test output.

4. The display device of claim 2, wherein the timing controller and the control unit further perform an error bit check operation to control register updating.

5. The display device of claim 4, wherein the error bit check operation comprises using the timing controller to calculate a first error check byte according to a first register and a second register transmitted from the timing controller; using the control unit to calculate a second error check byte according to the transmitted first register and the transmitted second register received by the control unit; and using the control unit to compare the first error check byte and the second error check byte to generate a comparison result to determine whether to update the first register and the second register.

6. The display device of claim 5, wherein if the comparison result shows that the first error check byte and the second error check byte are same, then the control unit updates the first register and the second register; and if the comparison result shows that the first error check byte and the second error check byte are different, then the control unit does not update the first register and the second register.

7. The display device of claim 4, wherein the display device is a liquid crystal display (LCD) with packet based point to point interface (PBPI).

8. A display device, comprising:
a timing controller; and
a plurality of source drivers, each comprising:
a comparing unit, for receiving a differential clock signal and a differential data signal from the timing controller, outputting a first clock signal according to the differential clock signal, and outputting a first data signal according to the differential data signal;
a clock generator, coupled to the comparing unit, for receiving a synchronizing signal and the first clock signal, generating a second clock signal according to the synchronizing signal and the first clock signal, and generating a plurality of third clock signals corresponding to the second clock signal;
a de-skew unit, coupled to the comparing unit, for receiving the first data signal and performing a de-skew operation for the first data signal to generate a second data signal;
a serial-to-parallel unit, coupled to the clock generator and the de-skew unit, for separating the second data signal according to the third clock signals to generate a plurality of third data signals; and
a control unit, coupled to the serial-to-parallel unit, for receiving the second clock signal and the third data signals.

9. The display device of claim 8, wherein the de-skew unit performs the de-skew operation for the first data signal according to a de-skew parameter; the de-skew unit further receives a test data signal with a predetermined test pattern and generates a test output; and the control unit further determines the de-skew parameter according to the test output.

10. The display device of claim 8, wherein the timing controller and the control unit further perform an error bit check operation to control register updating.

11. The display device of claim 10, wherein the error bit check operation comprises using the timing controller to calculate a first error check byte according to a first register and a second register transmitted from the timing controller; using the control unit to calculate a second error check byte according to the transmitted first register and the transmitted second register received by the control unit; and using the control unit to compare the first error check byte and the second error check byte to generate a comparison result to determine whether to update the first register and the second register.

12. The display device of claim 11, wherein if the comparison result shows that the first error check byte and the second error check byte are same, then the control unit updates the first register and the second register; and if the comparison result shows that the first error check byte and the second error check byte are different, then the control unit does not update the first register and the second register.

13. The display device of claim 10, wherein the display device is a liquid crystal display (LCD) with packet based point to point interface (PBPI).
